(19) United States
(12) Patent Application Publication
(10) Pub. No.: US 2014/0071674 A1
(43) Pub. Date: Mar. 13, 2014

(54) LIGHT EMITTING APPARATUS AND LENS

(71) Applicants: Han-Wen Tsai, Hsin-Chu (TW); Ming-Feng Kuo, Hsin-Chu (TW)

(72) Inventors: Han-Wen Tsai, Hsin-Chu (TW); Ming-Feng Kuo, Hsin-Chu (TW)

(73) Assignee: CORETRONIC CORPORATION, Hsin-Chu (TW)

(21) Appl. No.: 14/018,442

(22) Filed: Sep. 5, 2013

(30) Foreign Application Priority Data
Sep. 12, 2012 (TW) 101133358

(51) Int. Cl. F21V 5/00

(52) U.S. Cl. CPC F21V 5/007
USPC 362/237; 362/235; 362/335

(57) ABSTRACT

A light emitting apparatus, including at least one lens, at least one light emitting element, and a light emitting section, is provided. The lens includes a first curving surface and a second curving surface opposite to the first curving surface. The light emitting element is adapted for emitting a light beam and is disposed on a side of the second curving surface. The light emitting section has a central area and is disposed on a side of the first curving surface, wherein the light beam emitted from the light emitting element is transmitted out of the light emitting apparatus through the second curving surface, the first curving surface, and the light emitting section in sequence. An optical axis of the second curving surface is close to the central area with respect to an optical axis of the first curving surface. A lens is provided as well.

### CROSS-REFERENCE TO RELATED APPLICATION

This application claims the priority benefit of Taiwan application serial no. 101133358, filed on Sep. 12, 2012. The entirety of the above-mentioned patent application is hereby incorporated by reference herein and made a part of this specification.

### BACKGROUND OF THE INVENTION

1. Field of the Invention

The invention relates to an optical apparatus and an optical device and particularly relates to a light emitting apparatus and a lens.

2. Description of Related Art

Light emitting diodes (LEDs) have the advantages of smaller size, lower power consumption, higher light emitting efficiency, etc. and are gradually used to substitute the conventional illumination devices, such as fluorescent lamps and incandescent lamps, in recent years. However, the light field of LEDs is limited to a certain angle. Generally speaking, in comparison with the conventional lamps used for illumination, LEDs have narrower light field angles. For this reason, when LEDs are used as the light emitting elements of a planar light source, multiple LEDs are uniformly arranged so as to improve the uniformity of the light emitted from the planar light source. In addition, lenses may be respectively disposed on the uniformly-arranged LEDs to further improve the uniformity of light emission. However, when the conventional lenses are used, the light tends to have higher brightness right above the LEDs. Therefore, if one of the LEDs has lower brightness or does not emit light due to damage, the uniformity of the light emitted by the planar light source is significantly affected, which causes inconvenience to the user. Moreover, the uniformity of the light of the planar light source will be impaired if any of the LEDs is not turned on. For this reason, the user cannot turn off some of the LEDs to save power without affecting the uniformity of the light.

China Patent Publication No. CN102317676A discloses an illumination apparatus including an elliptic concave lens and a convex lens set, which enable a light source to control the characteristic of light distribution. Taiwan Patent Publication No. TW201224359 discloses an illumination device, which includes a carrier, a light emitting set, a lens unit, and a light guide plate for changing a light projection distance and an illumination range by rotating the lens unit. Taiwan Patent No. TWM340396 discloses a rectangular lens element for road side lamp, and the lens element includes a dioptric body disposed corresponding to a light source unit for expanding a diffusion angle of the light emitted by the light source unit. Taiwan Patent Publication No. TW201024625 discloses an optical device having a light emitting surface and a light incident surface, wherein the light emitting surface has a concave, and the light incident surface has a V-shaped or nearly V-shaped groove thereon for increasing an illumination range of a solid state light emitting device. Taiwan Patent No. TWI319629 discloses an LED module including a plurality of light emitting diodes and a plurality of lenses, wherein the curving surfaces of the lenses correspond to the light emitting diodes, and grooves on the lenses are used for diffusing the light with stronger energy emitted from the front side of the LEDs. Taiwan Patent No. TWM405521 discloses a light source unit including a light emitting device and a light controlling device, wherein the light controlling device includes a plurality of convex lens surfaces and tapered concave surfaces.

### SUMMARY OF THE INVENTION

The invention provides a light emitting apparatus adapted for generating light that is more uniform.

The invention provides a lens adapted for making a distribution of light intensity more uniform.

Other objectives and advantages of the invention are further illustrated by the technical features of the invention.

For achieving one or a part of or all the objectives or any other objectives, an embodiment of the invention provides a light emitting apparatus. The light emitting apparatus includes at least one lens, at least one light emitting element, and a light emitting section. The at least one lens includes a first curving surface and a second curving surface opposite to the first curving surface. The at least one light emitting element is disposed on a side of the second curving surface and adapted for emitting a light beam. The light emitting section has a central area and is disposed on a side of the first curving surface, wherein the light beam emitted from the light emitting element is transmitted out of the light emitting apparatus through the second curving surface, the first curving surface, and the light emitting section in sequence. An optical axis of the second curving surface is close to the central area with respect to an optical axis of the first curving surface.

An embodiment of the invention provides a lens which includes a first surface and a second surface. The first surface includes a plurality of first curving sub-surfaces. The second surface is opposite to the first surface and includes a plurality of second curving sub-surfaces and a central area. The second curving sub-surfaces are respectively opposite to the first curving sub-surfaces. An optical axis of each of the second curving sub-surfaces is close to the central area with respect to an optical axis of the first curving sub-surface.

Based on the above, in the light emitting apparatus disclosed in the embodiments of the invention, the optical axis of the second curving surface is close to the central area with respect to the optical axis of the first curving surface, and as a consequence, the light beam emitted by the light emitting element passes through the first curving surface and the second curving surface and is uniformly emitted out of the light emitting section. In the lens disclosed in the embodiments of the invention, the optical axis of the second curving sub-surface is close to the central area with respect to the optical axis of the first curving sub-surface, and thus at least a portion of the light that enters the lens via the second curving sub-surface is refracted towards the central area, so as to be uniformly emitted out of the first surface.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic cross-sectional view of a light emitting apparatus according to an embodiment of the invention.

FIG. 2 is a schematic view illustrating light emission of the light emitting apparatus according to the embodiment of FIG. 1.

FIG. 3 is a schematic perspective view of the light emitting apparatus according to the embodiment of FIG. 1.

FIG. 4A, FIG. 4B, and FIG. 4C respectively illustrate a schematic top view, cross-sectional view, and perspective view of a lens of FIG. 3.

FIG. 5 illustrates a modification of the lens of FIGS. 4A-4C.

FIG. 6 is a schematic perspective view illustrating another modification of the lens of FIGS. 4A-4C.

FIG. 7A, FIG. 7B, and FIG. 7C respectively illustrate a schematic top view, cross-sectional view, and perspective view of another modification of the lens of FIGS. 4A-4C.

FIG. 8A, FIG. 8B, and FIG. 8C respectively illustrate a schematic top view, cross-sectional view, and perspective view of yet another modification of the lens of FIGS. 4A-4C.

FIG. 9A and FIG. 9B illustrate conventional light emitting apparatuses for comparison.

FIG. 9C illustrates a light emitting section of a light emitting apparatus with a different lens configuration according to another embodiment of the invention.

FIG. 10 is a schematic top view of a light emitting apparatus according to another embodiment of the invention.

FIG. 11 is a schematic cross-sectional view of the light emitting apparatus according to the embodiment of FIG. 10.

FIG. 12 illustrates a modification of the light emitting apparatus according to the embodiment of FIG. 10.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

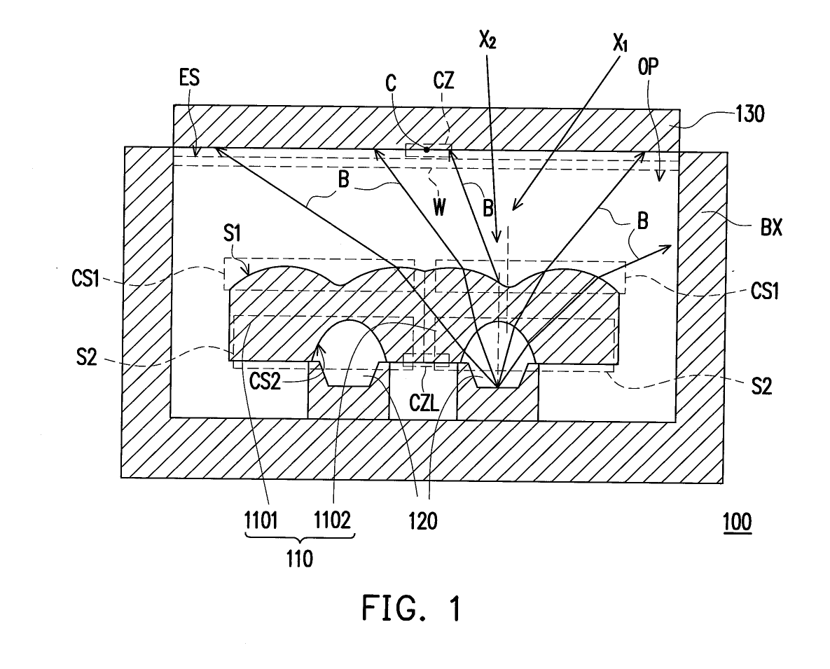

FIG. 1 is a schematic cross-sectional view of a light emitting apparatus according to an embodiment of the invention. Referring to FIG. 1, in this embodiment, a light emitting apparatus 100 includes at least one lens (e.g. lenses 1101 and 1102), at least one light emitting element 120, and a light emitting section ES. FIG. 1 depicts a plurality of the lenses 110 and a plurality of the light emitting elements 120 as an example in this embodiment, and each of the lenses (e.g. the lenses 1101 and 1102 of FIG. 1) includes a first curving surface CS1 and a second curving surface CS2 opposite to the first curving surface CS1. In this embodiment, the lenses 1101 and 1102 are integrally formed. That is, the lenses 1101 and 1102 can be regarded as one lens 110. The light emitting element 120 is disposed on a side of the second curving surface CS2 and emits a light beam B. Specifically, the light emitting element 120 may be a light emitting diode (LED) or other devices adapted for light emission. The light emitting section ES is disposed on a side of the first curving surface CS1 and includes a central area CZ. The light beam B emitted from the light emitting element 120 is transmitted out of the light emitting apparatus 100 through the second curving surface CS2, the first curving surface CS1, and the light emitting section ES in sequence. An optical axis X₂ of the second curving surface CS2 is close to the central area CZ with respect to an optical axis X₁ of the first curving surface CS1. Accordingly, the lens 110 uses the first curving surface CS1 and the second curving surface CS2 to refract the lights of the light beam B emitted from the light emitting element 120 at different angles (as shown in FIG. 1), such that the light beam B is uniformly emitted to the light emitting section ES after passing through the lens 110. Additionally, in the case that the number of the light emitting elements 120 decreases, the light emitting apparatus 100 may still adjust a distribution of the light beam B through the lens 110 to provide uniform light emission. For example, the light emitting apparatus 100 still generates uniform light emission through adjustment of the lens 110 when the number of the light emitting element 120 of the light emitting apparatus 100 is only one that emits light. Moreover, a part of the light emitting elements 120 may be selectively turned on for saving energy and power, and in that case the light emitting apparatus 100 still generates uniform light emission. In addition, the light emitting elements 120 may respectively emit lights of different colors to the light emitting section ES uniformly, and thereby the light emitting apparatus 100 may respectively turn on one light emitting element 120 to uniformly emit lights of various colors or simultaneously turn on multiple light emitting elements 120 to mix lights more uniformly for increasing brightness.

The light emitting apparatus 100 may further include a light transmissive plate 130 disposed on the light emitting section ES, wherein the central area CZ of the light emitting section ES is also a central area of the light transmissive plate 130. The light transmissive plate 130 may be a diffusion plate. In other embodiments, the light transmissive plate 130 may be a transparent plate. In addition, the light emitting apparatus 100 may further include a light box BX having an opening OP. The opening OP surrounds and defines the light emitting section ES, and the light emitting section ES is rectangular, for instance. The lens 110 and the light emitting element 120 are disposed in the light box BX.

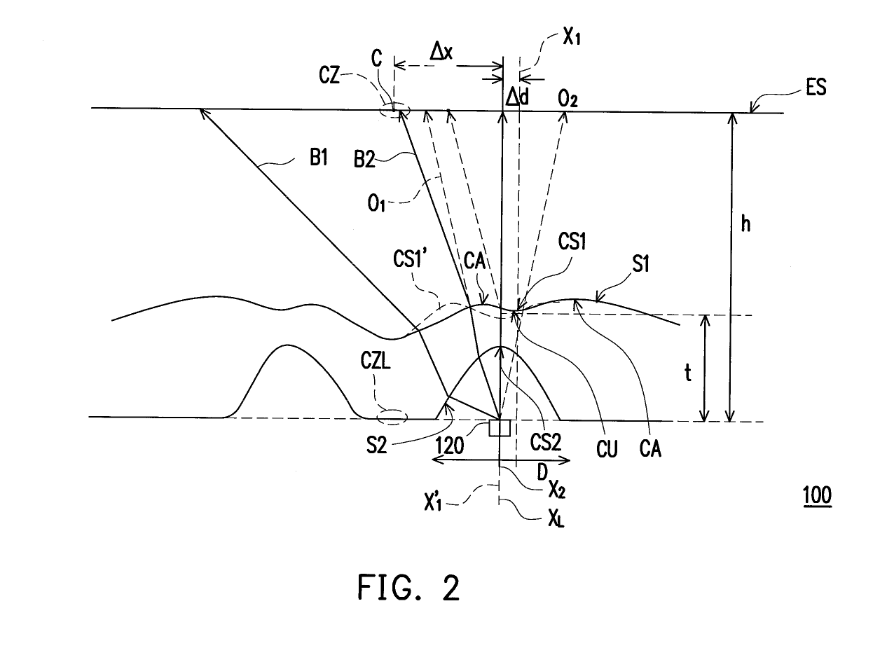

More specifically, FIG. 2 illustrates light emission of the light emitting apparatus according to the embodiment of FIG. 1. Referring to FIG. 1 and FIG. 2, the lens 110 includes a first surface S1 and a second surface S2. The first surface S1 includes a plurality of the first curving surfaces CS1. The second surface S2 is opposite to the first surface S1 and includes a plurality of the second curving surfaces CS2 and a central area CZL. The second curving surfaces CS2 are respectively opposite to the first curving surfaces CS1. In this embodiment, the first curving surfaces CS1 are sub-surfaces of the first surface S1, and the second curving surfaces CS2 are sub-surfaces of the second surface S2. The optical axis X₂ of each of the second curving surfaces CS2 is close to the central area CZL of the second surface S2 with respect to the optical axis X₁ of the first curving surface CS1. Accordingly, the lens 110 uses the first curving surfaces CS1 of the first surface S1 and the second curving surfaces CS2 of the second surface S2 to widen an illumination range of the light beam B emitted from the light emitting element 120 and make the light beam B more uniform. For instance, because the first curving surfaces CS1 and the second curving surfaces CS2 on the lens 110 have different partial curvatures, a part of the light beam, i.e. light beams B1 and B2, emitted at different angles from the light emitting element 120 of FIG. 2 are refracted to the light emitting section ES uniformly, so as to prevent most of the light beam B from being concentrated around an optical axis X_{L} of the light emitting element 120. For example, a first curving surface CS1′ of FIG. 2 illustrates a situation that the optical axis X₁ of the first curving surface CS1 does not shift away from the central area CZL of the second surface S2, wherein the illumination ranges of light beams O₁ and O₂ are concentrated right above the optical axis X_{L} of the light emitting element 120, and as a result light emission is not uniform and is partially intense on the light emitting section ES. When the optical axis X₁′ of the first curving surface CS1′ shifts away from the central area CZL of the second surface S2, the light beams O₁ and O₂ shift to the directions of the light beams B1 and B2 and diffuse towards and near the central area CZ, so as to reduce the phenomenon of non-uniform light intensity.

To be more specific, with reference to FIG. 2, in this embodiment, each of the first curving surfaces CS1 includes a curving concave CU and a curving convex CA, wherein the optical axis X₁ of each of the first curving surfaces CS1 passes through the curving concave CU, and the curving convex CA surrounds the curving concave CU. Each of the second curving surfaces CS2 is a curving concave, and a shift of the optical axis X₂ of the second curving surface CS2 relative to the optical axis X₁ of the corresponding first curving surface CS1 is less than a half of an internal diameter D of the curving concave. For example, in this embodiment, the optical axis X₂ of the second curving surface CS2 substantially coincides with the optical axis X_{L} of the light emitting element 120. A distance between the optical axis X_{L} of the light emitting element 120 to a central position C of the light emitting section ES is Δx, and a distance between the optical axis X₁ of the first curving surface CS1 and the optical axis X₂ of the second curving surface CS2 is Δd. A distance from a center of the curving concave CU of the first curving surface CS1 to a light emitting surface of the light emitting element 120 in a direction parallel to the optical axis X₁ is t. A distance from the light emitting surface of the light emitting element 120 to the light emitting section ES in the direction parallel to the optical axis X₁ is h. More specifically, the distance Δd between the optical axis X₁ of the first curving surface CS1 and the optical axis X₂ of the second curving surface CS2 satisfies the following relation:

$$Δ d ≅ \frac{( Δ x \cdot t )}{( {n}_{L} \cdot h )} < \frac{D}{2}$$

D represents the internal diameter of the curving concave of the second curving surface CS2, and n_{L} is a relative refractive index of the lens 110. It is known from the above that Δd is the shift of the optical axis X₂ of the second curving surface CS2 with respect to the optical axis X₁ of the first curving surface CS1. Referring to FIG. 2, when the optical axis X₂ of the second curving surface CS2 is close to the central area CZL of the second surface S2 with respect to the optical axis X₁ of the first curving surface CS1, the light beam B emitted from the light emitting element 120 is refracted towards the central area CZ of the light emitting section ES as well. Accordingly, the lens 110 changes the distribution of the light beam B, such that the light beam B is uniformly emitted from the light emitting section ES. Consequently, the light emitting apparatus 100 generates light with uniform intensity, and the phenomenon that the light beam B is concentrated right above the light emitting element 120 and causes non-uniform light emission is prevented. It is noted that, in this embodiment, the central area CZL of the second surface S2 and the central area. CZ of the light emitting section ES overlap with each other.

Moreover, the lens 110 may be disposed at any position in the light box BX as long as the position of the lens 110 satisfies the following relation:

$$\frac{W}{h} \leq 10$$

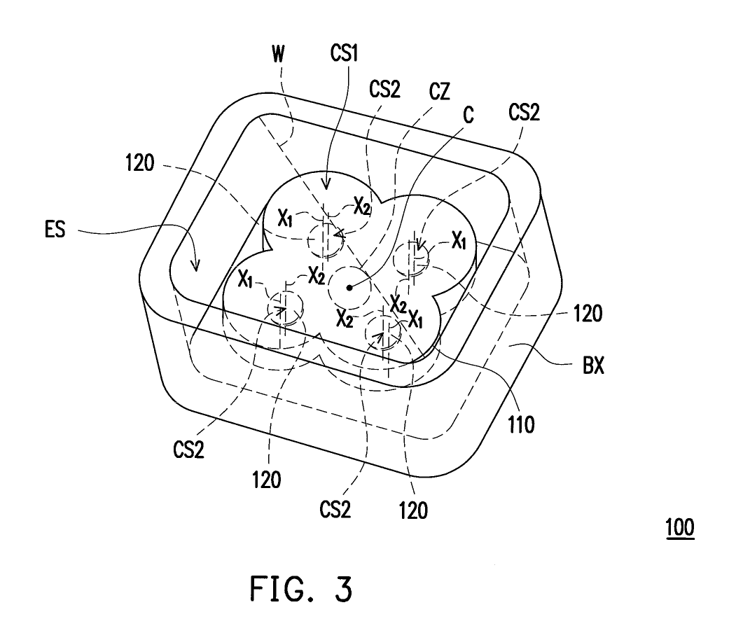

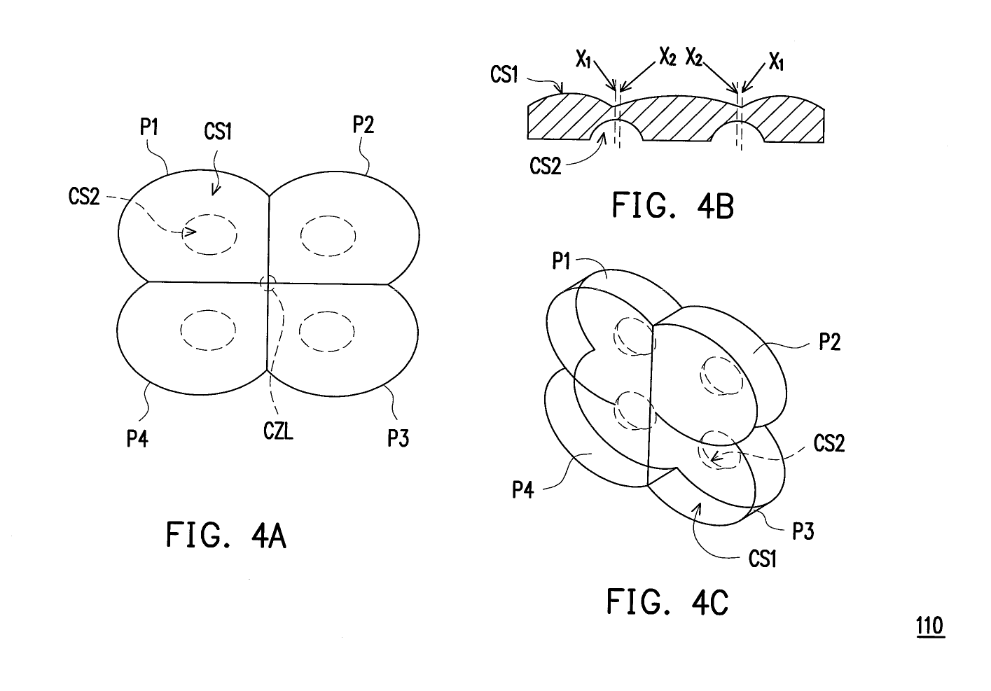

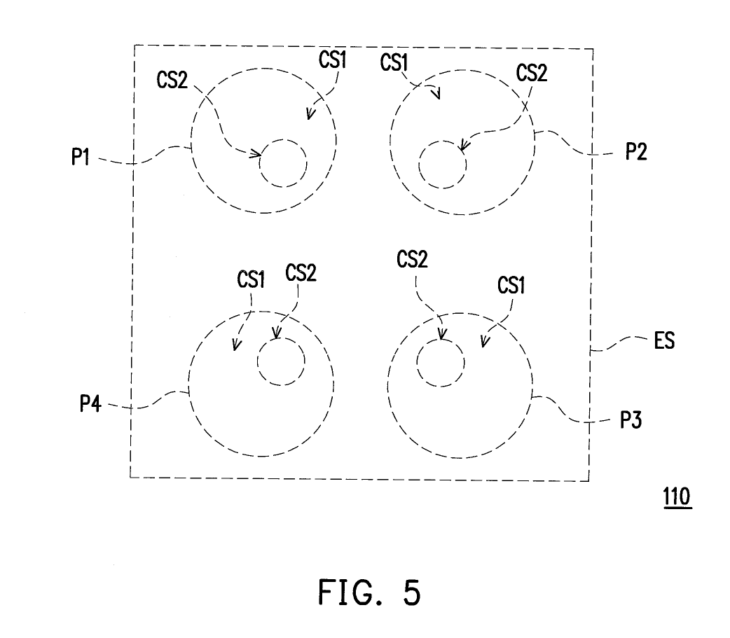

W represents a distance of the largest illumination range of the light emitting section ES, and in this embodiment, W is a diagonal line of the rectangular light emitting section ES, for example. Within this range, there is no restriction on the arrangement of the lens 110 and the light emitting element 120. The light beam B can be uniformly emitted to the light emitting section ES simply by adjusting a shape of the lens 110, i.e. shapes of the first curving surface CS1 and the second curving surface CS2. FIG. 3 is a schematic perspective view of the light emitting apparatus according to the embodiment of FIG. 1. FIG. 4A, FIG. 4B, and FIG. 4C respectively illustrate a schematic top view, cross-sectional view, and perspective view of a lens of FIG. 3. FIG. 5 illustrates a modification of the lens of FIGS. 4A-4C. Please refer to FIG. 3 to FIG. 5. In this embodiment, the light emitting apparatus 100 includes four lenses 110 and four light emitting elements 120, arranged in a way as shown in FIG. 3, for example. The light emitting elements 120 respectively correspond to the lenses 110. The lenses 110 may be integrally formed or be formed by connecting four lens parts P1 to P4, as shown in FIGS. 4A-4C. Because the lenses 110 may form a single lens, the time required for alignment of the light emitting elements 120 and the lenses 110 during assembly is saved, and assembly difficulty and error are reduced to increase production. It is known from FIG. 4A that the optical axes X₂ of the second curving surfaces CS2 all shift towards the central area CZL with respect to the optical axes X₁ of the first curving surfaces CS1 and form the lenses 110 with a symmetrical shape in this embodiment. Therefore, the light beams B from the light emitting elements 120 are all emitted uniformly to the central area CZ of the light emitting section ES. That is, when only one of the light emitting elements 120 is turned on, uniform light emission can still be achieved through adjusting the distribution of the light beam B by the lenses 110. When more light emitting elements 120 are turned on, better uniformity is achieved and brightness is increased.

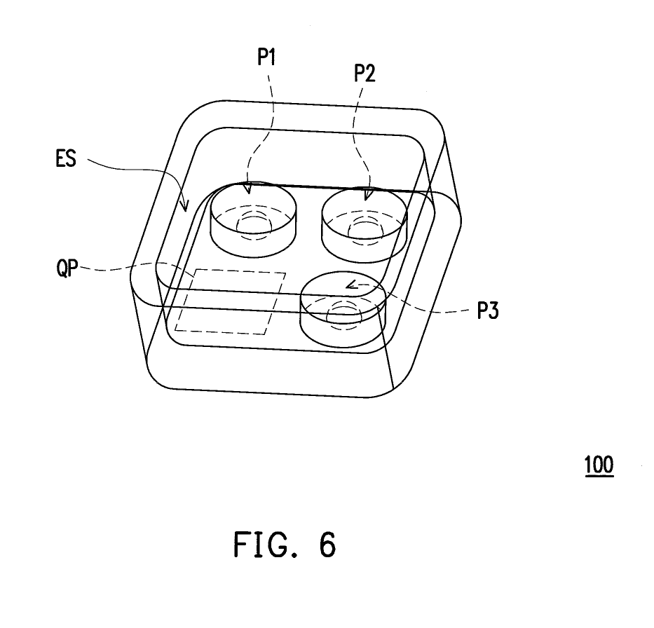

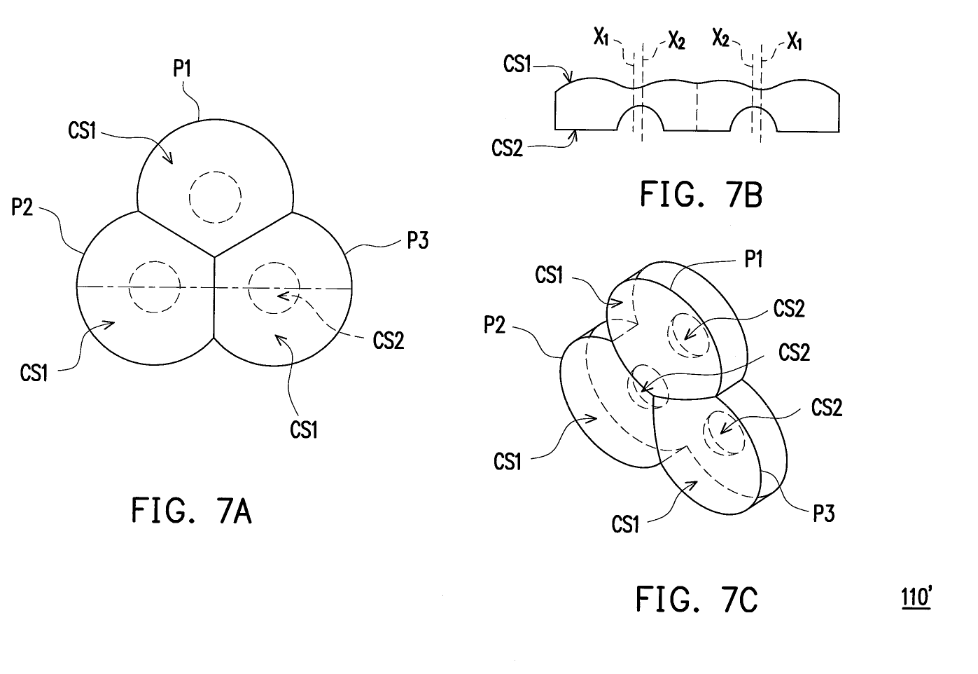

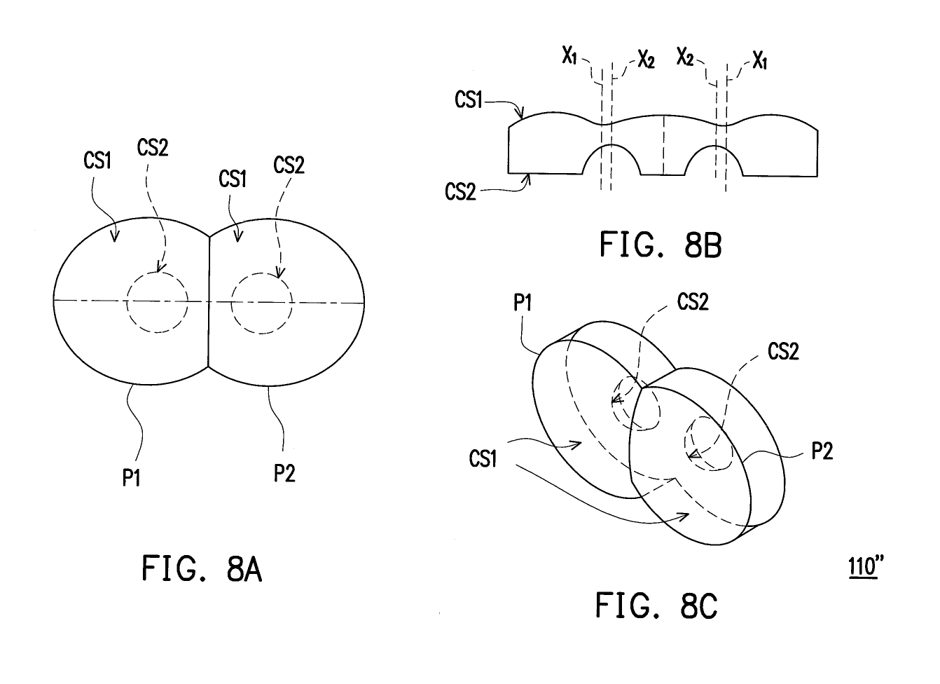

FIG. 6 is a schematic perspective view illustrating another modification of the lens of FIGS. 4A-4C. FIG. 7A, FIG. 7B, and FIG. 7C respectively illustrate a schematic top view, cross-sectional view, and perspective view of another modification of the lens of FIGS. 4A-4C. FIG. 8A, FIG. 8B, and FIG. 8C respectively illustrate a schematic top view, cross-sectional view, and perspective view of yet another modification of the lens of FIGS. 4A-4C. Please refer to FIG. 4A to FIG. 8C. The lenses 110 may also be modified in the following way. For example, the lenses 110 may be separated from each other, i.e. the separated four lens parts P1 to P4 illustrated in FIG. 5. Because each of the light emitting elements 120 can uniformly emit light to the light emitting section ES through the lens 110, one of the light emitting elements 120 that correspond to the four lens parts P1 to P4 may be replaced with an element QP, such as a circuit element or other structures, as shown in FIG. 6, without affecting the uniformity of the light emission of the light emitting apparatus 100. Otherwise, the element QP may be replaced with a light emitting element of a different color, so as to satisfy different needs, but the invention is not limited to the above. Moreover, in actual application, the shape and size of the lens 110 and the number of the light emitting elements may be varied according to the shape and size of the illumination area as required. For example, the lens 110′ composed of three lens parts P1 to P3 as shown in FIG. 7A to FIG. 7C and the lens 110″ composed of two lens parts P1 and P2 as shown in FIG. 8A to FIG. 8C both achieve efficiency similar to the efficiency of the lens 110 of FIGS. 4A-4C, and the invention is not limited to the above.

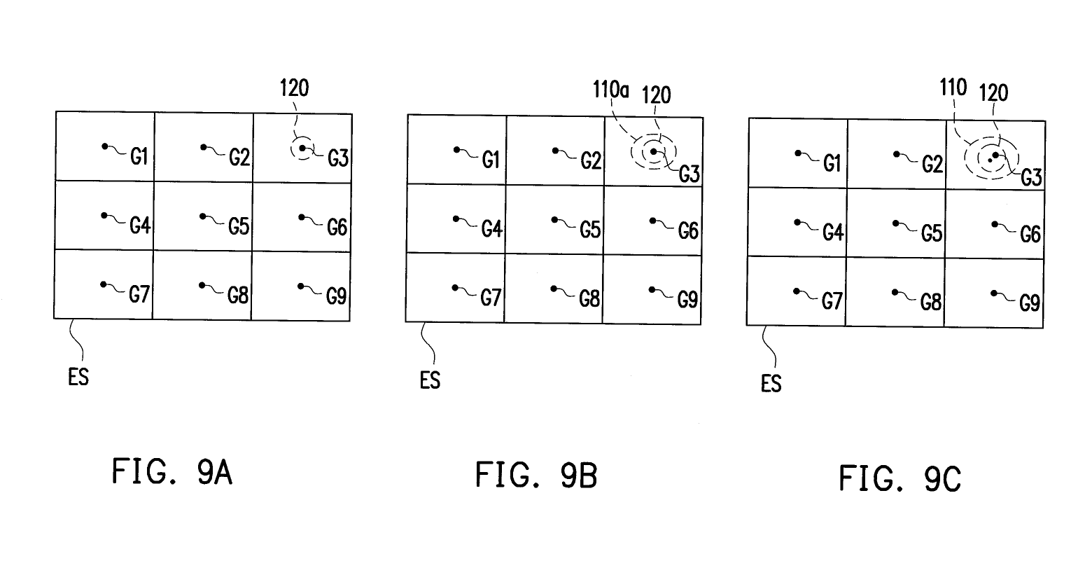

FIG. 9A and FIG. 9B illustrate conventional light emitting apparatuses for comparison. FIG. 9C illustrates a light emitting section of a light emitting apparatus with a different lens configuration according to another embodiment of the invention. Referring to FIG. 9A to FIG. 9C, for example, the light emitting section ES in FIG. 9A to FIG. 9C is equally divided into nine sections (i.e. nine rectangular grids). FIG. 9A illustrates a situation that the light emitting element 120 is disposed in the section at the right upper corner of the light emitting section ES without a lens. Luminance values at nine points of the light emitting section ES are shown in Table 1:

TABLE 1
Luminance values at nine points

| | | |
|---|---|---|
| G1: 441 | G2: 989 | G3: 933 |
| G4: 442 | G5: 884 | G6: 878 |
| G7: 321 | G8: 495 | G9: 450 |

Average luminance: 648(nits)
Uniformity: 32%

The luminance values at the nine points refer to the luminance values that respectively correspond to the central points G1 to G9 of the nine sections of the light emitting section ES. According to the data of Table 1, it is known that the light emitted from the light emitting element 120 is concentrated around the central point G3, i.e. near where the light emitting element 120 is located, and the luminance value at the central point G7 is apparently lower than the luminance value at the central point G3, which causes non-uniform luminance. FIG. 9B illustrates a situation that the light emitting element 120 is disposed in the section at the right upper corner of the light emitting section ES with a lens 110a that has the same optical axis as the light emitting element 120. Luminance values at nine points of the light emitting section ES are shown in Table 2:

TABLE 2
Luminance values at nine points

| | | |
|---|---|---|
| G1: 530 | G2: 600 | G3: 689 |
| G4: 573 | G5: 557 | G6: 631 |
| G7: 529 | G8: 521 | G9: 564 |

Average luminance: 557(nits), Gain = 0.86
Uniformity: 76%

According to the data of Table 2, it is known that the luminance is more uniform, but a Gain of the overall luminance of FIG. 9B is 0.86 to a Gain of FIG. 9A (i.e. 86% of the overall luminance of FIG. 9A). In other words, the lens 110a of FIG. 9B increases an average value of light emission but significantly decreases the luminance. FIG. 9C illustrates a situation that the light emitting element 120 is disposed in the section at the right upper corner of the light emitting section ES and the optical axis of the light emitting element 120 is close to the central point G5 with respect to the optical axis of the lens 110, which is similar to the configuration of the lens 110 in the embodiment of FIG. 1. Luminance values at nine points of the light emitting section ES are shown in Table 3:

TABLE 3
Luminance values at nine points

| | | |
|---|---|---|
| G1: 580 | G2: 669 | G3: 581 |
| G4: 597 | G5: 710 | G6: 707 |
| G7: 499 | G8: 606 | G9: 591 |

Average luminance: 616(nits), Gain = 0.95
Uniformity: 70%

It is known from Table 3 that the light emission is uniform, and a Gain of the overall luminance of FIG. 9C reaches 0.95 (i.e. 95% of the overall luminance of FIG. 9A). In other words, the lens 110 of FIG. 9C not only increases the uniformity of light emission but also maintains favorable overall luminance. That is to say, the light emitting apparatus 100 in the embodiment of FIG. 1 improves uniformity of light emission without greatly impairing the overall luminance. However, it is noted that the data and configurations of FIG. 9A to FIG. 9C are merely examples and shall not be construed as limitations to the scope of the invention.

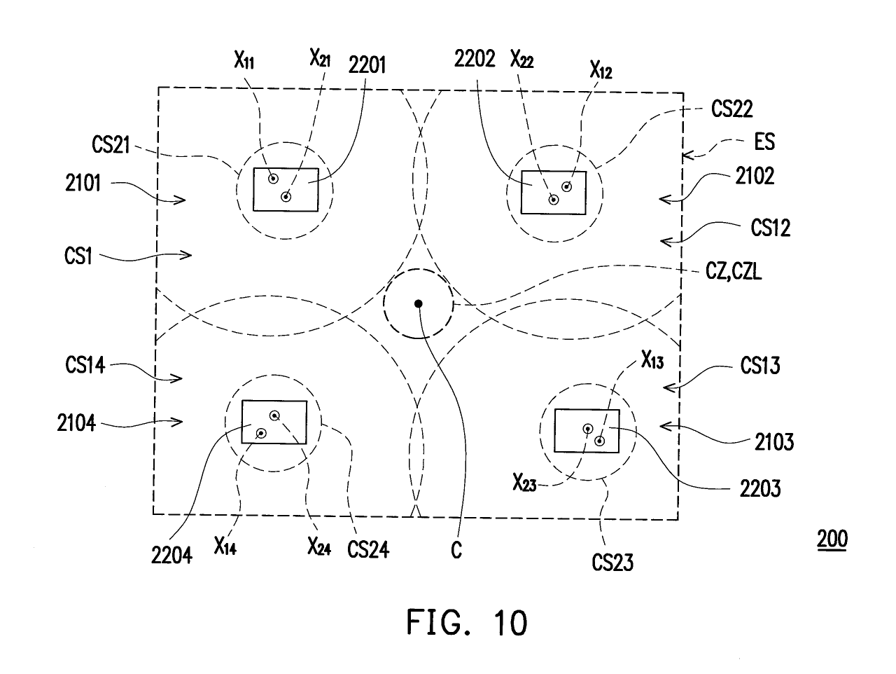

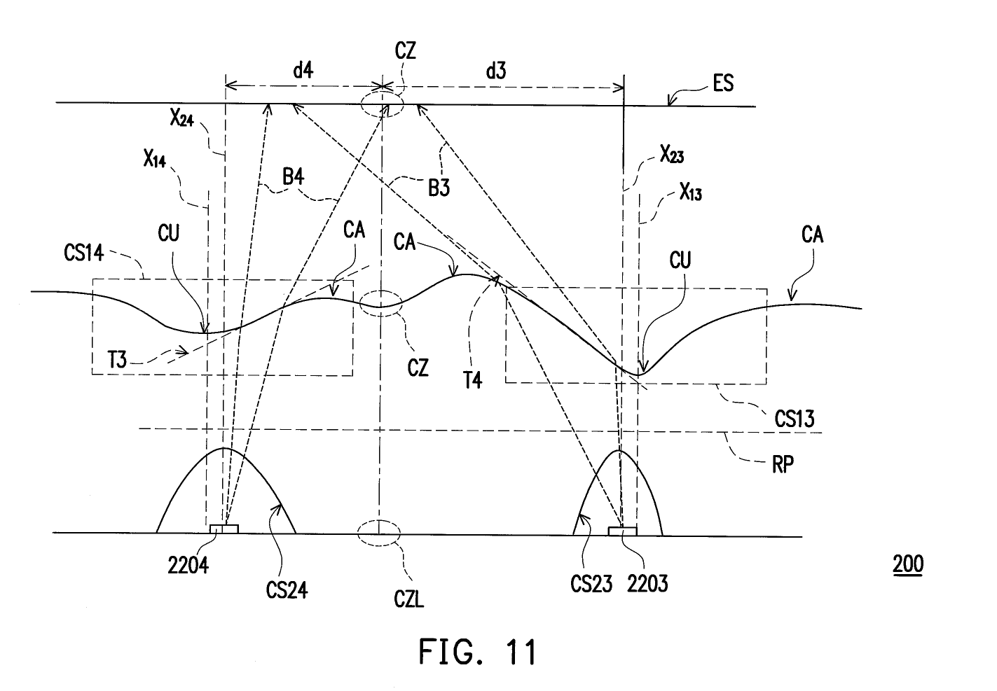

FIG. 10 is a schematic top view of a light emitting apparatus according to another embodiment of the invention. FIG. 11 is a schematic cross-sectional view of the light emitting apparatus according to the embodiment of FIG. 10. Referring to FIG. 10 and FIG. 11, this embodiment is similar to the embodiment of FIG. 1 and FIG. 2, and a difference lies in that: in this embodiment, a light emitting apparatus 200 includes light emitting elements 220 (including light emitting elements 2201, 2202, 2203, and 2204) that respectively correspond to lenses 210 (including lens parts 2101, 2102, 2103, and 2104). Distances between the first curving surfaces CS1 (including CS11, CS12, CS13, and CS14) of the lenses 210 and the central area CZ (or the central area CZL) in a direction perpendicular to the optical axes X₁ of the first curving surfaces CS1 (including an optical axis X₁₁ of the first curving surface CS11, an optical axis X₁₂ of the first curving surface CS12, an optical axis X₁₃ of the first curving surface CS13, and an optical axis X₁₄ of the first curving surface CS14) are at least partially unequal to each other. Moreover, distances between the second curving surfaces CS2 (including CS21, CS22, CS23, and CS24) and the central area CZ in a direction perpendicular to the optical axes X₂ of the light emitting elements 210, i.e. the optical axes X₂ of the second curving surfaces CS2 (including an optical axis X₂₁ of the light emitting element 2201, an optical axis X₂₂ of the light emitting element 2202, an optical axis X₂₃ of the light emitting element 2203, and an optical axis X₂₄ of the light emitting element 2204) are at least partially unequal to each other. In addition, the first curving surfaces CS13 and CS14 respectively include a curving concave CU and a curving convex CA. The optical axes X₁₃ and X₁₄ of the first curving surfaces CS13 and CS14 respectively pass through the curving concaves CU, and the curving convex CA surrounds the curving concave CU. Referring to the first curving surfaces CS13 and CS14, an absolute value of a slope at a junction between the curving concave CU and the curving convex CA of the first curving surface CS13 away from the central area CZL (i.e. a slope of a tangent T4 at an inflection point of the partial curving line) is greater than an absolute value of a slope at a junction between the curving concave CU and the curving convex CA of the first curving surface CS14 near the central area CZL (i.e. a slope of a tangent T3 at an inflection point of the partial curving line). The slope refers to a slope with respect to a reference plane RP, and the reference plane RP is perpendicular to the optical axis of the first curving surface. That is to say, the lenses 210 are asymmetrical, unlike the symmetrical lenses 110 in the embodiments of FIG. 1 and FIGS. 4A-4C. Moreover, the configuration of the light emitting elements 220 and the shape of the lenses 210 in the embodiment of FIG. 10 is merely an example and should not be construed as a limitation to the scope of the invention.

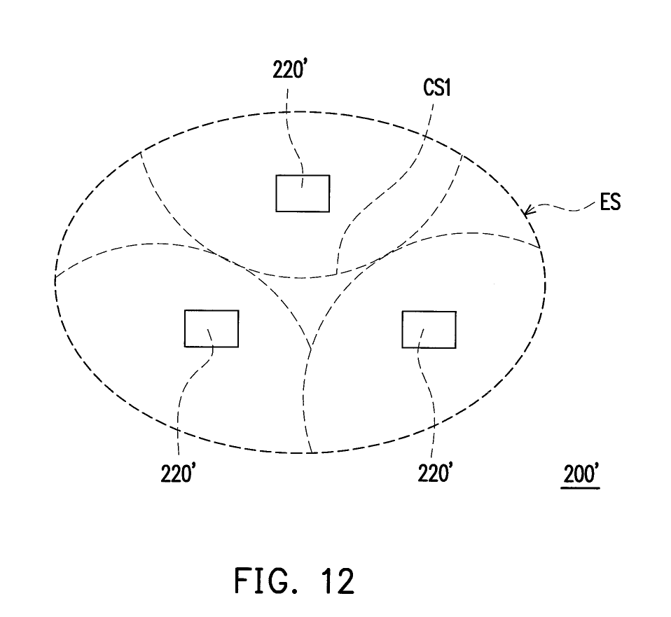

FIG. 12 illustrates a modification of the light emitting apparatus according to the embodiment of FIG. 10. Please refer to FIG. 10 to FIG. 12. To be more specific, in the embodiment of FIG. 10 and FIG. 11, a distance d4 between the optical axis X₂₄ of the light emitting element 2204 and the central area CZ in the direction perpendicular to the optical axis X₁ of the first curving surface CS1 is shorter than a distance d3 between the optical axis X₂₃ of the light emitting element 2203 and the central area CZ in the direction perpendicular to the optical axis X₁ of the first curving surface CS1. Therefore, as shown in FIG. 11, a degree that the first curving surface CS14 of the lens 210 refracts a partial light beam B4 emitted from the light emitting element 2204 towards the central area CZ of the light emitting section ES is less than a degree that the first curving surface CS13 refracts a partial light beam B3 emitted from the light emitting element 2203 towards the central area CZ. In other words, in this embodiment, the lenses 210 make the light beam from the light emitting elements 220 (whether farther from or closer to the central area CZL) to be emitted uniformly to the light emitting section ES through adjustment of the first curving surfaces CS1. That is, the lenses 210 may be disposed in different positions corresponding to the light emitting elements 220 and be applied to designs with various irregular shapes to achieve uniform light emission of the light emitting section ES. Referring to the second curving surfaces CS2, a curvature near the optical axis X₂₃ of the second curving surface CS23 that is farther from the central area CZL may be made greater than a curvature near the optical axis X₂₄ of the second curving surface CS24 that is closer to the central area CZL, so as to increase the degree to which the partial light beam B3 from the light emitting element 2203, which is located away from the central area CZ, is refracted towards the central area CZ of the light emitting section ES. In other words, the lenses 210 make the light beam from the light emitting elements 220 (whether farther from or closer to the central area CZL) to be emitted uniformly to the light emitting section ES through adjustment of the second curving surfaces CS2. That is to say, the lenses 210 may be disposed in different positions corresponding to the light emitting elements 220 and the first curving surfaces CS1 and the second curving surfaces CS2 are designed accordingly, so as to achieve uniform light emission of the light emitting section ES. It is noted that the shapes and numbers of the light emitting elements 220 and the lenses 210 described in this embodiment are merely examples for illustrating the disclosure. In other embodiments, the shapes and numbers of the light emitting elements 220 and the lenses 210 may be modified for actual application (e.g. a light emitting apparatus 200′ of FIG. 12). For example, the light emitting section ES of the light emitting apparatus 200′ of FIG. 12 is elliptic, but the invention is not limited thereto.

In conclusion of the above, the light emitting apparatus and the lens disclosed in the embodiments of the invention have at least the following advantages: in the light emitting apparatus of the embodiments of the invention, the optical axis of the second curving surface is close to the central area with respect to the optical axis of the first curving surface, and thus the light beam emitted by the light emitting element passes through the first curving surface and the second curving surface and is emitted out of the light emitting section uniformly. In the lens disclosed in the embodiments of the invention, the optical axis of the second curving sub-surface is close to the central area with respect to the optical axis of the first curving sub-surface, and therefore at least a portion of the light that enters the lens via the second curving sub-surface is refracted towards the central area, so as to be uniformly emitted out of the first surface.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Terms, such as “first,” “second,” etc., used in the specification or claims are for naming elements or distinguishing different embodiments or claims, and are not intended to indicate the upper or lower limit of the number of the elements.

What is claimed is:

1. A light emitting apparatus, comprising:
at least one lens comprising a first curving surface and a second curving surface opposite to the first curving surface;
at least one light emitting element disposed on a side of the second curving surface for emitting a light beam; and
a light emitting section disposed on a side of the first curving surface and comprising a central area, wherein the light beam emitted from the light emitting element is transmitted out of the light emitting apparatus through the second curving surface, the first curving surface, and the light emitting section in sequence, and wherein an optical axis of the second curving surface is close to the central area with respect to an optical axis of the first curving surface.

2. The light emitting apparatus according to claim 1, wherein the second curving surface is a curving concave, and a shift of the optical axis of the second curving surface with respect to the optical axis of the first curving surface is less than a half of an internal diameter of the curving concave.

3. The light emitting apparatus according to claim 1, wherein the optical axis of the second curving surface substantially coincides with an optical axis of the light emitting element.

4. The light emitting apparatus according to claim 1, wherein the first curving surface comprises a curving concave and a curving convex, the optical axis of the first curving surface passes through the curving concave, and the curving convex surrounds the curving concave.

5. The light emitting apparatus according to claim 1, further comprising a light transmissive plate disposed on the light emitting section, wherein the central area of the light emitting section is also a central area of the light transmissive plate.

6. The light emitting apparatus according to claim 5, wherein the light transmissive plate is a diffusion plate.

7. The light emitting apparatus according to claim 1, further comprising a light box having an opening, wherein the opening surrounds and defines the light emitting section, and the lens and the light emitting element are disposed in the light box.

8. The light emitting apparatus according to claim 7, wherein a position of the lens in the light box satisfies the following relation:
$$\frac{W}{h} \leq 10$$
wherein W is a distance of a largest illumination range of the light emitting section, and h is a distance between a light emitting surface of the light emitting element and the light emitting section in a direction parallel to the optical axis of the first curving surface.

9. The light emitting apparatus according to claim 1, wherein the at least one lens comprises a plurality of lenses, and the at least one light emitting element comprises a plurality of light emitting elements, wherein the light emitting elements respectively correspond to the lenses, and the lenses are integrally formed or connected with each other to form one piece.

10. The light emitting apparatus according to claim 1, wherein the at least one lens comprises a plurality of lenses, and the at least one light emitting element comprises a plurality of light emitting elements, wherein the light emitting elements respectively correspond to the lenses, and the lenses are separated from each other.

11. The light emitting apparatus according to claim 1, wherein the at least one lens comprises a plurality of lenses, and the at least one light emitting element comprises a plurality of light emitting elements, wherein the light emitting elements respectively correspond to the lenses, and distances between the lenses and the central area in a direction perpendicular to the optical axis of the first curving surface are at least partially unequal.

12. The light emitting apparatus according to claim 11, wherein, among the lenses, a curvature near the optical axis of the second curving surface of the lens that is farther from the central area is greater than a curvature near the optical axis of the second curving surface of the lens that is closer to the central area.

13. The light emitting apparatus according to claim 11, wherein the first curving surface of each of the lenses comprises a curving concave and a curving convex; the optical axis of the first curving surface passes through the curving concave; the curving convex surrounds the curving concave; and among the lenses, a slope at a junction between the curving concave and the curving convex of the lens that is farther from the central area is greater than a slope at a junction between the curving concave and the curving convex of the lens that is closer to the central area, wherein the slope is a slope with respect to a reference plane, and the reference plane is perpendicular to the optical axis of the first curving surface.

14. The light emitting apparatus according to claim 1, wherein the optical axis of the second curving surface substantially is close to a central position of the light emitting section with respect to the optical axis of the first curving surface.

15. A lens, comprising:
a first surface comprising a plurality of first curving sub-surfaces; and
a second surface opposite to the first surface, comprising:
a plurality of second curving sub-surfaces respectively opposite to the first curving sub-surfaces; and
a central area, wherein an optical axis of each of the second curving sub-surfaces is close to the central area with respect to an optical axis of the corresponding first curving sub-surface.

16. The lens according to claim 15, wherein each of the second curving sub-surfaces is a curving concave, and a shift of the optical axis of the second curving sub-surface with respect to the optical axis of the first curving sub-surface is less than a half of an internal diameter of the curving concave.

17. The lens according to claim 15, wherein each of the first curving sub-surfaces comprises a curving concave and a curving convex, the optical axis of the first curving sub-surface passes through the curving concave, and the curving convex surrounds the curving concave.

18. The lens according to claim 15, wherein distances between the first curving sub-surfaces and the central area in a direction perpendicular to the optical axes of the first curving sub-surfaces are at least partially unequal to each other, and distances between the second curving sub-surfaces and the central area in a direction perpendicular to the optical axes of the second curving sub-surfaces are at least partially unequal to each other.

19. The lens according to claim 18, wherein, among the second curving sub-surfaces, a curvature near the optical axis of the second curving sub-surface that is farther from the central area is greater than a curvature near the optical axis of the second curving sub-surface that is closer to the central area.

20. The lens according to claim 18, wherein each of the first curving sub-surfaces comprises a curving concave and a curving convex; the optical axis of the first curving sub-surface passes through the curving concave; the curving convex surrounds the curving concave; and among the first curving sub-surfaces, a slope at a junction between the curving concave and the curving convex of the first curving sub-surface that is farther from the central area is greater than a slope at a junction between the curving concave and the curving convex of the first curving sub-surface that is closer to the central area, wherein the slope is a slope with respect to a reference plane, and the reference plane is perpendicular to the optical axis of the first curving sub-surface.

21. The lens according to claim 15, wherein the optical axis of the second curving sub-surface is substantially close to a central position of the second surface with respect to the optical axis of the first curving sub-surface.
